(19) United States
(12) Patent Application Publication
(10) Pub. No.: US 2015/0261647 A1
(43) Pub. Date: Sep. 17, 2015

(54) INFORMATION SYSTEM CONSTRUCTION ASSISTANCE DEVICE, INFORMATION SYSTEM CONSTRUCTION ASSISTANCE METHOD, AND RECORDING MEDIUM

(71) Applicant: NEC CORPORATION, Tokyo (JP)

(72) Inventor: Hiroshi Sakaki, Tokyo (JP)

(21) Appl. No.: 14/432,942

(22) PCT Filed: Sep. 17, 2013
(86) PCT No.: PCT/JP2013/005469

§ 371 Date: Apr. 1, 2015

(30) Foreign Application Priority Data
Oct. 2, 2012 (JP) 2012-220617

(51) Int. Cl. G06F 11/34

(52) U.S. Cl. CPC G06F 11/3447

(57) ABSTRACT

Disclosed are an information system construction assistance device and the like that simply implement construction assistance that meets user demands.

The information system construction assistance device includes a system model selection unit which, when construction requirements are input, selects a system model that meets construction requirements from a system model information DB, an operation information acquisition unit which acquires operation information from an operation information DB on the basis of a selected system model group, a parameter calculation unit which uses parameters included in the operation information to calculate evaluation parameters, a performance evaluation unit which uses the evaluation parameters to evaluate the performance of the selected system model, a sizing factor determination unit which compares the result of the evaluation with the input construction requirements to determine whether or not a sizing factor for the selected system model is specified while maintaining construction requirements set mandatory, and a relaxed conditions presentation unit which, when the sizing factor is not specified, presents relaxed construction requirements.

### TECHNICAL FIELD

The present invention relates to an information system construction assistance device, an information system construction assistance method and an information system construction assistance program.

### BACKGROUND ART

The advance of the cloud computing technology has enabled users using cloud environments to centralize servers, storages or the like that are required for operating information systems on virtual data centers. This allows the users to relatively simply construct information systems that have scales required for their operations and to manage the information systems. Patent Literature 1 discloses an information processing device that, in response to a request to execute an application from a user terminal in an information system in a cloud environment, constructs an execution environment for the application in the cloud environment.

### CITATION LIST

### Patent Literature

### [PTL 1]

Japanese Laid-open Patent Publication No. 2010-218049

### SUMMARY OF INVENTION

### Technical Problem

In the information processing device disclosed in PTL 1, different execution environments are preset for different combinations of resources, middleware or the like that are included in operational requirements for applications. When the information processing device receives a request to execute an application, the information processing device selects an execution environment that meets operational requirements for the application from among the preset execution environments. In other words, the user allows the application to operate in an execution environment that meets all of the operational requirements for the application for which the user has issued the execution request. On the other hand, if there is not an environment that meets all requirements, the information processing device relaxes the requirements. However, PTL 1 does not disclose means for finding out which of the requirements needs to be relaxed, to what degree, and what kind of environment is provided. Therefore, in such a case, the user has to repeat trial and error using various requirements in order to obtain a satisfactory environment.

The present invention has been made to solve the problem described above. One of the objects of the present invention is to provide an information system construction assistance device, an information system construction assistance method, and an information system construction assistance program that are capable of simply implement construction assistance that meets user demands.

### Solution to Problem

An information system construction assistance device which is one aspect of the present invention includes: a system model selection unit which, when a construction requirement for a system to be constructed which is an information system to be constructed is input, selects a system model that meets the construction requirements from among system models which are set for each of sets of system design information stored in advance; an operation information acquisition unit which acquires operation information about existing systems which are information systems already constructed on the basis of the system model selected by the system model selection unit and a similar system model similar to the system model; a parameter calculation unit which uses a parameter included in the operation information acquired by the operation information acquisition unit to calculate an evaluation parameter to be used in evaluating performance of the system model; a performance evaluation unit which uses the evaluation parameter calculated by the parameter calculation unit to evaluate performance of the system model selected by the system model selection unit; a server factor determination unit which compares the performance of the system model evaluated by the performance evaluation unit with the input construction requirements to determine whether or not a server factor which is a factor that determines a size relating to a server included in the design information about the system model selected by the system model selection unit is specified while maintaining at least one or more of the construction requirements that are set mandatory; and a relaxed conditions presentation unit which, when the server factor determination unit determines that the server factor is not specified, presents a relaxed version of the construction requirements.

An information system construction assistance method which is another aspect of the present invention includes: a system model selection step of, when a construction requirement for a system to be constructed which is an information system to be constructed is input, selecting a system model that meets the construction requirements from among system models which are set for each of sets of system design information stored in advance; an operation information acquisition step of acquiring operation information about existing systems which are information systems already constructed on the basis of the system model selected at the system model selection step and a similar system model similar to the system model; a parameter calculation step of using a parameter included in the operation information acquired at the operation information acquisition step to calculate an evaluation parameter to be used in evaluating performance of the system model; a performance evaluation step of using the evaluation parameter calculated at the parameter calculation step to evaluate performance of the system model selected at the system model selection step; a server factor determination step of comparing the performance of the system model evaluated at the performance evaluation step with the input construction requirements to determine whether or not a server factor which is a factor that determines a size relating to a server included in the design information about the system model selected at the system model selection step is specified while maintaining at least one or more of the construction requirements that are set mandatory; and a relaxed conditions presentation step of, when it is determined at the server factor determination step that the server factor is not specified, presenting a relaxed version of the construction requirements.

An information system construction assistance program which is another aspect of the present invention causes a computer to execute: a system model selection step of, when a construction requirement for a system to be constructed which is an information system to be constructed is input, selecting a system model that meets the construction requirements from among system models which are set for each of sets of system design information stored in advance; an operation information acquisition step of acquiring operation information about existing system which are information systems already constructed on the basis of the system model selected at the system model selection step and a similar system model similar to the system model; a parameter calculation step of using a parameter included in the operation information acquired at the operation information acquisition step to calculate an evaluation parameter to be used in evaluating performance of the system model; a performance evaluation step of using the evaluation parameter calculated at the parameter calculation step to evaluate performance of the system model selected at the system model selection step; a server factor determination step of comparing the performance of the system model evaluated at the performance evaluation step with the input construction requirements to determine whether or not a server factor which is a factor that determines a size relating to a server included in the design information about the system model selected at the system model selection step is specified while maintaining at least one or more of the construction requirements that are set mandatory; and a relaxed conditions presentation step of, when it is determined at the server factor determination step that the server factor is not specified, presenting a relaxed version of the construction requirements.

The object of the present invention can also be achieved by a computer-readable recoding medium on which the program is stored.

### Advantageous Effects of Invention

According to the present invention, construction assistance that meets user demands can be simply implemented.

### BRIEF DESCRIPTION OF DRAWINGS

FIG. 1 is a diagram illustrating a configuration of an information system construction assistance device in an exemplary embodiment of the present invention.

FIG. 2 illustrates an example of a screen used by a user in constructing an information system in an exemplary embodiment of the present invention.

FIG. 3 illustrates an example of a configuration of a screen displayed in a service level requirements input area illustrated in FIG. 2.

FIG. 4 illustrates an example of a configuration of a screen displayed in a functional requirements selection area illustrated in FIG. 2.

FIG. 5 illustrates an example of a configuration of a screen displayed in a candidate system model display area illustrated in FIG. 2.

FIG. 6 illustrates an example of a screen displaying evaluation parameters in an exemplary embodiment of the present invention.

FIG. 7A illustrates an example of a screen displaying results of a simulation in an exemplary embodiment of the present invention.

FIG. 7B illustrates an example of a screen displaying relaxed conditions in an exemplary embodiment of the present invention.

FIG. 8 is a flowchart illustrating a procedure in assisting in constructing an information system in an exemplary embodiment of the present invention.

FIG. 9 is a flowchart illustrating a procedure in assisting in constructing an information system in an exemplary embodiment of the present invention.

FIG. 10 is a diagram illustrating another configuration of a device according to the present invention.

FIG. 11 is a diagram illustrating a configuration of an information system construction assistance device in a variation of the present invention.

FIG. 12 is a diagram illustrating an example of a hardware configuration of an information system construction assistance device of the present invention.

### DESCRIPTION OF EMBODIMENTS

Preferred exemplary embodiments of an information system construction assistance device, an information system construction assistance method and information system construction assistance program according to the present invention will be described with reference to the accompanying drawings. An information system construction assistance device in an exemplary embodiment is a device which evaluates the performance of various information systems constructed using virtual machines in a cloud environment and assists a user in constructing an information system that meets construction requirements presented by the user through interaction with the user.

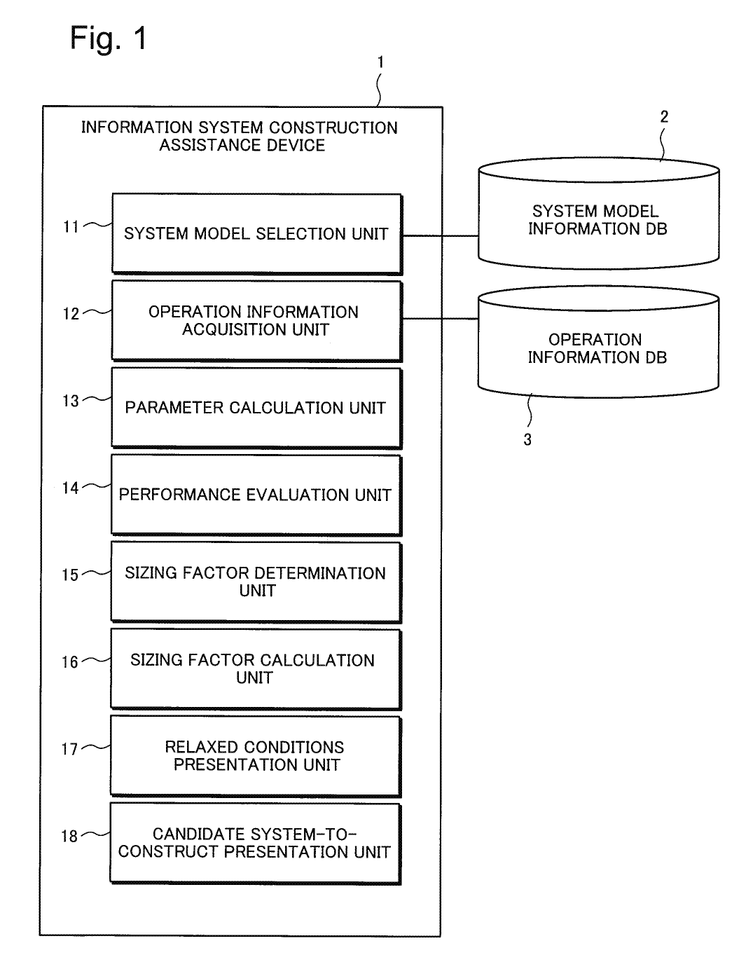

A configuration of an information system construction assistance device in an exemplary embodiment will be described first with reference to FIG. 1. As illustrated in FIG. 1, an information system construction assistance device 1 includes, for example, a system model selection unit 11, an operation information acquisition unit 12, a parameter calculation unit 13, a performance evaluation unit 14, a sizing factor determination unit 15, a sizing factor calculation unit 16, a relaxed conditions presentation unit 17, and a candidate system-to-construct presentation unit 18 as functional units.

The blocks illustrated in the block diagrams are represented for convenience of explanation. Implementations of the present invention described by taking exemplary embodiments as examples are not limited to configurations illustrated in the block diagrams.

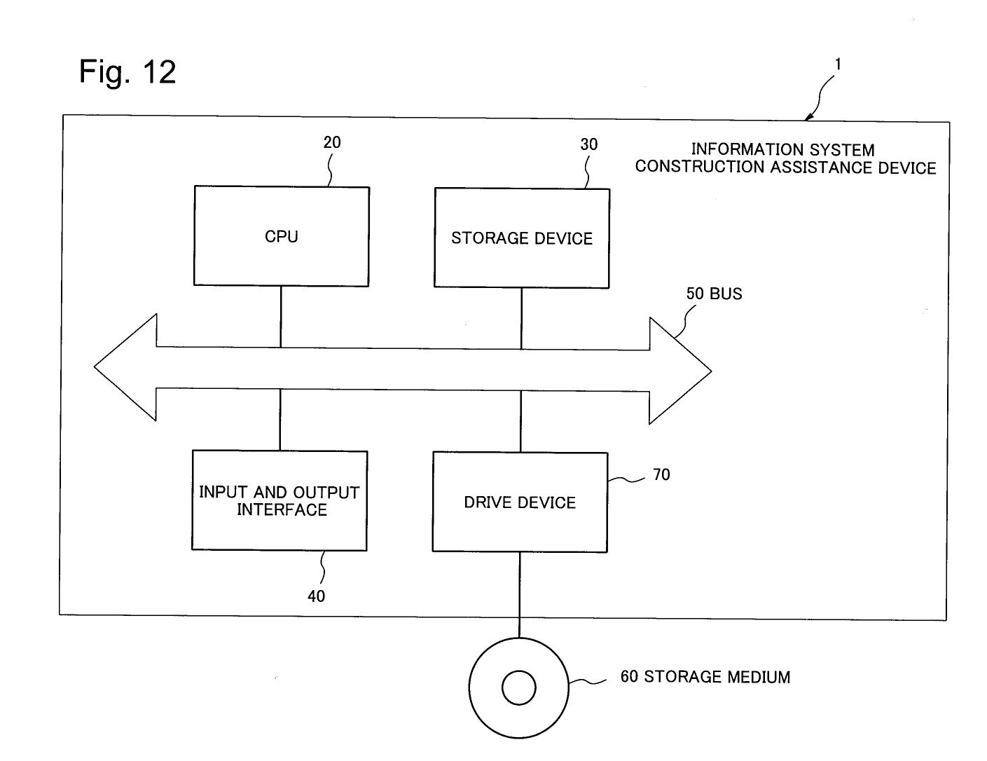

FIG. 12 is a diagram illustrating an exemplary hardware configuration of the information system construction assistance device 1. The information system construction assistance device 1 includes a CPU (Central Processing Unit) 20, a storage device 30, and an input and output interface 40, for example as physical components. The storage device 30 includes a ROM (Read Only Memory) and an HDD (Hard Disk Drive) for storing programs and data processed by the CPU 20 and a RAM (Random Access Memory) or the like used for work areas used primarily for control processing, for example. These elements are interconnected through a bus 50. The CPU 20 executes a computer program (hereinafter referred to as the “program”) stored on the ROM to process messages received through the input and output interface 40 and data loaded in the RAM, thereby implementing the functions of the components of the information system construction assistance device 1. Note that the present invention described by taking this exemplary embodiment and variations, which will be described later, as examples can also be embodied by a nonvolatile storage medium 60, such as a compact disc, on which such program is stored. The program stored on the storage medium 60 is read by a drive device 70, for example. The exemplary hardware configuration of the information system construction assistance device 1 illustrated in FIG. 12 is also applicable to variations, which will be described later. Note that the information system construction assistance device 1 may be a dedicated device. The information system construction assistance device 1 may be configured by interconnecting two or more physically separated devices via a wired or wireless link.

When a user inputs construction requirements for an information system that the user is planning to construct (hereinafter referred to as the “system to be constructed”), the system model selection unit 11 selects a system model that meets the construction requirements with reference to a system model information DB (database, hereinafter referred to as “DB”) 2. When there are a plurality of system models that meet the construction requirements, the system model selection unit 11 selects the plurality of system models.

Construction requirements may be functional requirements and service level requirements, for example. The functional requirements are requirements for determining the functions to be carried out by an application and may include functions such as data processing, data store, image analysis, response generation, statistical processing, or inventory control functions, for example. The service level requirements are requirements for determining a guaranteed level of quality provided by the system to be constructed and may include guaranteed levels of throughput, maximum CPU usage rate, maximum disk usage rate, network usage rate, TAT (Turn Around Time) or the like, for example.

A system model is a model that is set for each set of design information for constructing an information system. Examples of design information include information describing a configuration of a network, a configuration of a server, relationship between components of an application, process flows representing operations of an application or the like.

The system model information DB 2 is a database storing system model information including design information for information systems already constructed (hereinafter referred to as “existing systems”). The system model information DB 2 is designed to allow search for system model information using a construction requirement as a key. The system model information DB 2 may be provided inside or external to the information system construction assistance device 1.

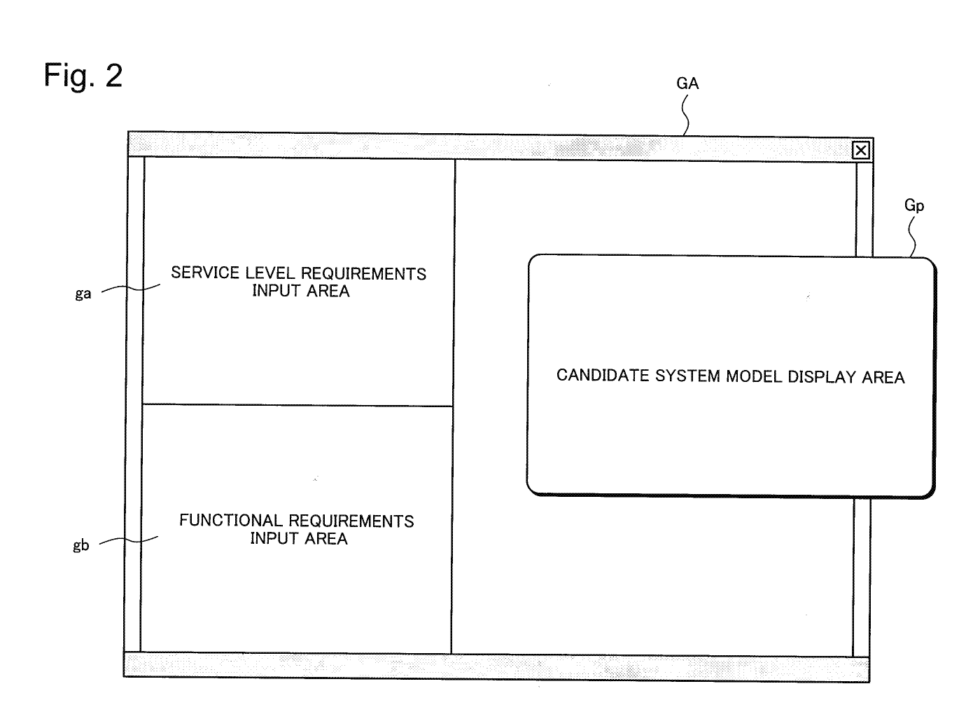

The user operates a user terminal (not depicted) to access the information system construction assistance device 1 and uses various screens provided by the information system construction assistance device 1 to determines a system to be constructed. A screen used by a user will be described with reference to FIG. 2. FIG. 2 illustrates an example of a screen used by the user in constructing an information system. An area ga for inputting service level requirements and an area gb for inputting functional requirements are provided on the display screen GA. In addition, an area Gp displaying one or more system models that meet construction requirements as candidates when the system models are selected is popped up on the display screen GA.

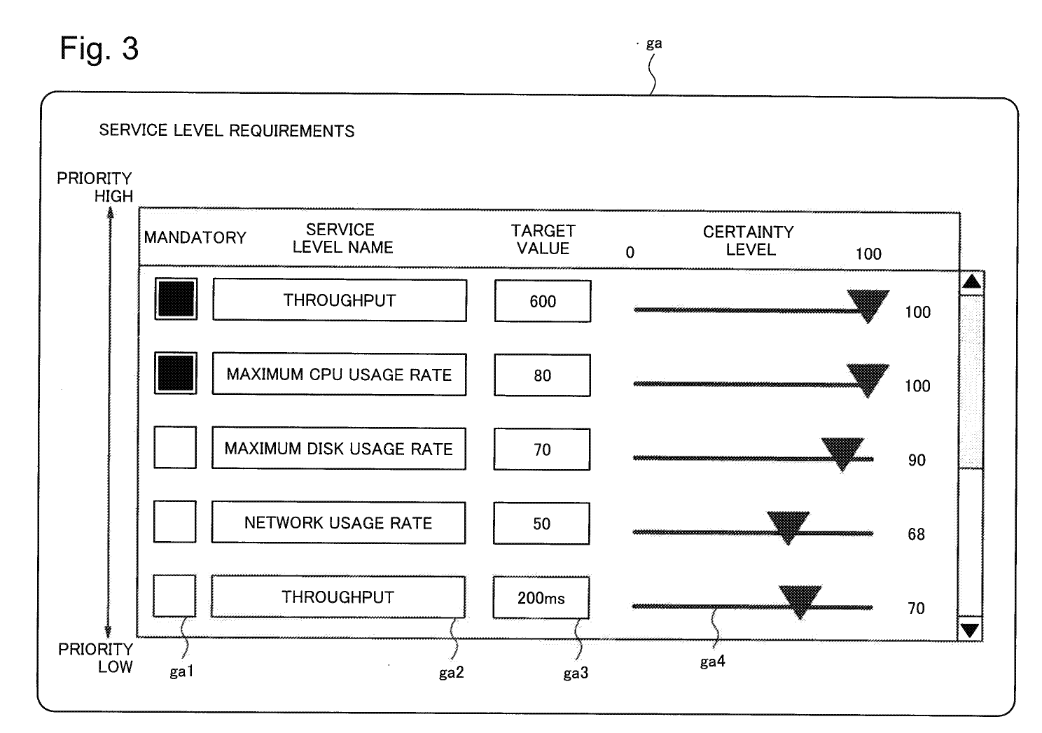

FIG. 3 illustrates an example of a configuration of a screen displayed in the service level requirements input area ga. As illustrated in FIG. 3, service level name entries ga2 and a target value entries ga3 for inputting service level names and target values which are set as service level requirements are displayed in the service level requirements input area ga. Sets of service level name entry ga2 and target value entry ga3 that are in upper rows in the input area ga are given higher priorities in evaluating the performance of a system model. In other words, the entry input in the top row has the highest priority, entries in lower rows have lower priorities, and the entry input in the bottom row has the lowest priority.

“Throughput”, “maximum CPU usage rate”, “maximum disk usage rate”, “network usage rate” and “TAT” are input in the service level name entries ga2 in FIG. 3, from top to bottom. “600, “80”, “70”, “50” and “200 ms” are input in the target value entries ga3 associated with the service level names.

Furthermore, a mandatory entry ga1 is displayed for each of the service level name entries ga2 in the service level requirements input area ga. The mandatory entry ga1 is a check entry for choosing whether to set the achievement of the target value for the associated service level name entry ga2 as being mandatory in evaluating the performance of a system model.

In FIG. 3, the mandatory entries ga1 associated with the “throughput” and the “maximum CPU usage rate” are checked. In this case, the “throughput” and the “maximum CPU usage rate” are set as being mandatory and therefore the highest priorities are given to the “throughput” and the “maximum CPU usage rate”. The priorities of the “maximum disk usage rate”, the “network usage rate”, and the “TAT” descend in this order. Specifically, candidate system models to be presented to the user are system models that have at least a “throughput” of “600” or higher and a “maximum CPU usage rate” of less than or equal to “80” %.

Furthermore, a level bar ga4 is displayed for each of the service level name entries ga2 in the service level requirements input area ga. The level bar ga4 indicates the degree of possibility of the target value of the service level name entry ga2 associated with the level bar ga4 being achieved, on the basis of results of a simulation of a system model selected by the user as a system model to be evaluated.

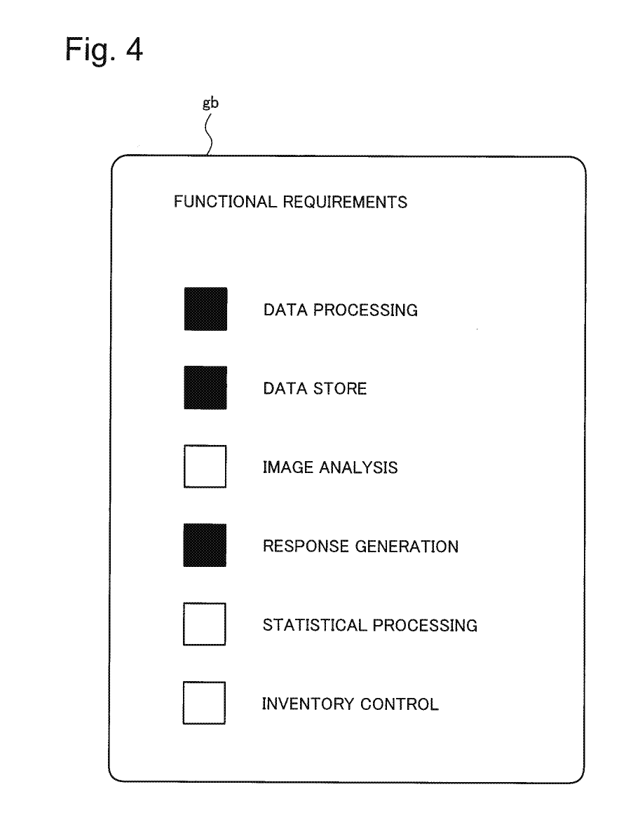

FIG. 4 illustrates an exemplary configuration of a screen displayed in the functional requirements selection area gb. As illustrated in FIG. 4, entries for selectively inputting data processing, data store, image analysis, response generation, statistical processing and inventory control as functional requirements are displayed in the functional requirement selectin area gb. The user uses the functional requirements selection area gb to input desired functional requirements for the system to be constructed.

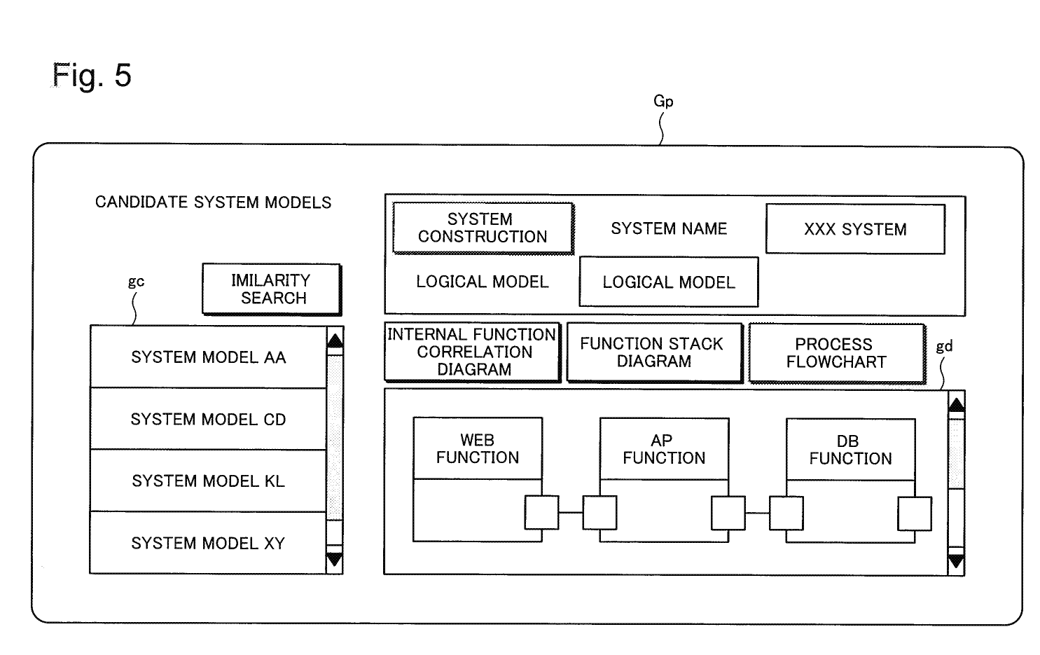

FIG. 5 illustrates an exemplary configuration of a screen displayed in the candidate system model display area Gp. As illustrated in FIG. 5, an area gc for selecting a system model to be used in performance evaluation and an area gd for displaying a model diagram of the system model selected in the selection area gc are provided in the candidate system model display area Gp.

One or more system models selected by the system model selection unit 11 are displayed in the selection area gc. Examples of model diagrams displayed in the display area gd include an internal function correlation diagram, a function stack diagram, a process flowchart or the like. The user uses the candidate system model display area Gp to cause execution of performance evaluation of a system to be constructed or construction of an information system. Specifically, for example the user selects one system model in the selection area gc and clicks a similarity search button to cause execution of performance evaluation of a system to be constructed. If the user accepts the result of the evaluation, the user clicks a system construction button to cause construction of the information system to be executed.

The operation information acquisition unit 12 illustrated in FIG. 1 acquires operation information about an existing system constructed in the past by using a system model selected by the system model selection unit 11 from an operation information DB 3. When there are a plurality of system models selected by the system model selection unit 11, the operation information acquisition unit 12 acquires operation information about an existing system that uses a system model selected by the user from the selection area gc from the operation information DB 3.

The operation information acquisition unit 12 further acquires operation information about an existing system constructed in the past by using a system model similar to the system model selected by the system model selection unit 11 from the operation information DB 3. For convenience of explanation, a set of a system model selected by the system model selection unit 11 and a system model similar to the system model is referred to as a “selected system model group” in this exemplary embodiment.

A system model similar to a selected system model may be a system model that has design information that differs from the design information about the selected system model only in a server sizing factor, for example.

The server sizing factor is a factor (server factor) that determines a size relating to a server or servers and may include the number of servers, the number of CPU cores included in a server, or the like, for example.

The operation information is information managed by an operator who operates the information system and may include the load on the CPU, the number of requests handled, a hard-disk failure history, and the like, for example.

The operation information DB 3 is a database storing operation information about existing systems. The operation information DB 3 is designed to allow search for operation information using a system model as a key. The operation information DB 3 may be provided inside or external to the information system construction assistance device 1.

The parameter calculation unit 13 uses parameters included in operation information acquired by the operation information acquisition unit 12 to calculate evaluation parameters used in evaluating non-functional requirements such as the performance, reliability, scalability, security or mission critical nature (hereinafter referred to as the “MC nature”) of an information system. The higher the indicator of quality such reliability, availability, or maintainability, or the indicator of performance such as the performance value, the higher the indicator of a non-functional requirement is.

The parameters may be the request arrival rate, the average transmission size of application messages, Web load represented by the average CPU time, Web read load represented by disk read time, Web write load represented by disk write time, the average size of SQL (Structured Query Language) execution, application load represented by average CPU time, application write load represented by disk write time, or the like, for example.

The evaluation parameters are provided in accordance with parameters included in operation information about a selected system model group acquired by the operation information acquisition unit 12. The averages of the parameter values of the selected system model group are set as the values of the evaluation parameters.

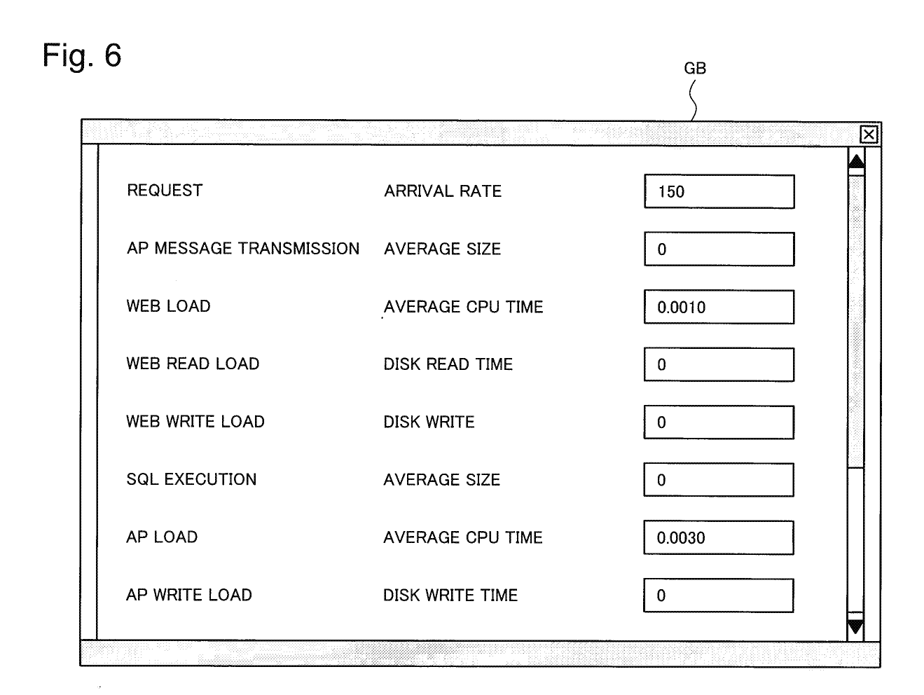

FIG. 6 illustrates an example of a screen displaying evaluation parameters. As illustrated in FIG. 6, a list of evaluation parameter item names and values of evaluation parameters is displayed in the evaluation parameter display screen GB.

The performance evaluation unit 14 depicted in FIG. 1 uses evaluation parameters calculated by the parameter calculation unit 13 to evaluate the performance of a system model selected by the system model selection unit 11.

The sizing factor determination unit 15 compares the results of evaluation by the performance evaluation unit 14 with service level requirements input by the user to determine whether or not a sizing factor of a system model selected by the system model selection unit 11 is specified while maintaining at least service level requirements that are set as being mandatory among the service level requirements. A situation where a sizing factor is not specified is when the sizing factor exceeds a specified upper limit or is below a specified lower limit.

Specifically, the sizing factor determination unit 15 determines whether or not a sizing factor for a system model selected by the system model selection unit 11 can be determined while the performance of the selected system model meets at least the service level requirements whose mandatory entry ga1 in FIG. 3 are checked. Service level requirements whose mandatory entry ga1 in FIG. 3 are not checked do not necessarily need to be met in this case. However, the determination as to whether the sizing factor can be determined is made by setting weighting such that the degree to which the service level requirements having higher priorities are not met is smaller.

When the sizing factor determination unit 15 determines that the sizing factor is not determined, the sizing factor calculation unit 16 relaxes service level requirements input by the user and then calculates a sizing factor. A service level requirement may be relaxed to any degree in a range in which the sizing factor can be determined.

The relaxed conditions presentation unit 17 presents service level requirements relaxed by the sizing factor calculation unit 16.

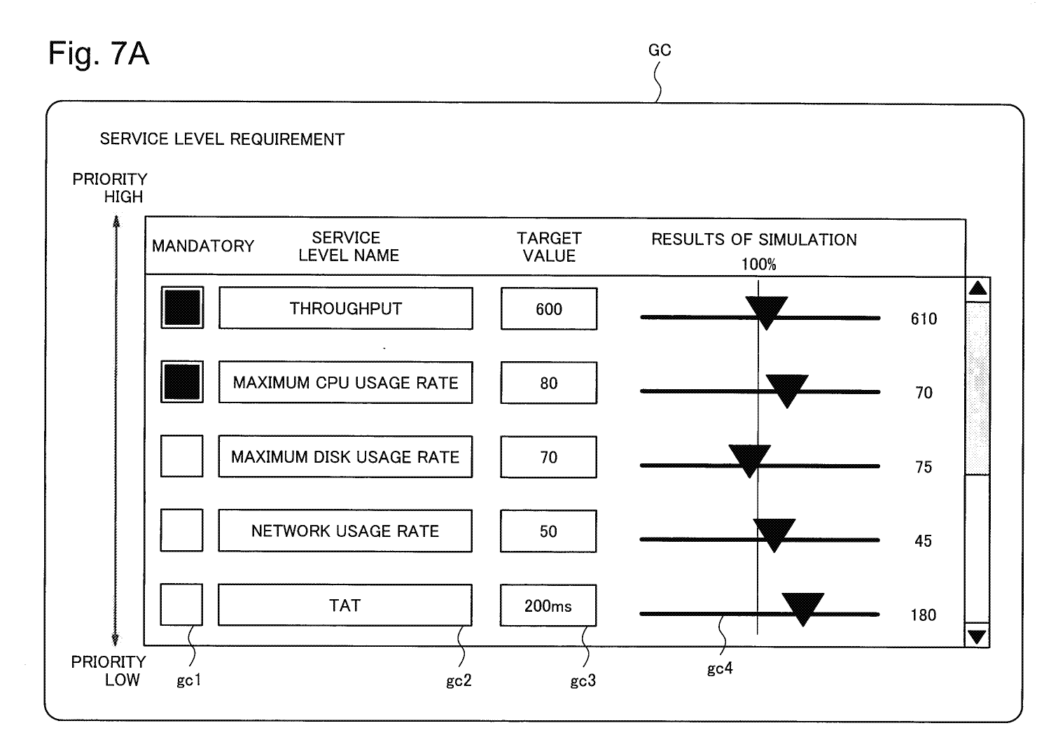

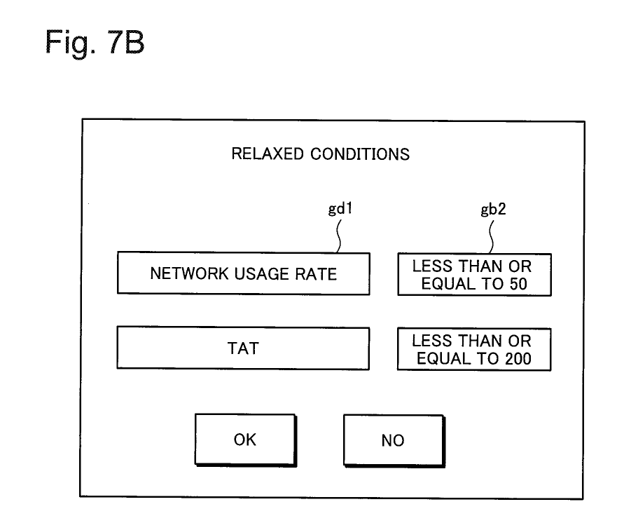

FIG. 7B illustrates an example of a screen displaying relaxed conditions. As illustrated in FIG. 7B, service level requirement name entries gd1 which display the names of relaxed service level requirements and target value entries gd2 which display relaxed target values are displayed in a relaxed conditions presentation screen GD. FIG. 7A illustrates an example of a screen that displays results of a simulation. Mandatory entries gc1, service level name entries gc2, target vale entries gc3 and simulation result bars gc4 are displayed in a simulation result display screen GC.

When the sizing factor determination unit 15 determines that a sizing factor is specified, the candidate system-to-construct presentation unit 18 presents, as a candidate for the system to be constructed, to a use terminal, an information system that can be constructed using a system model for which the sizing factor is set.

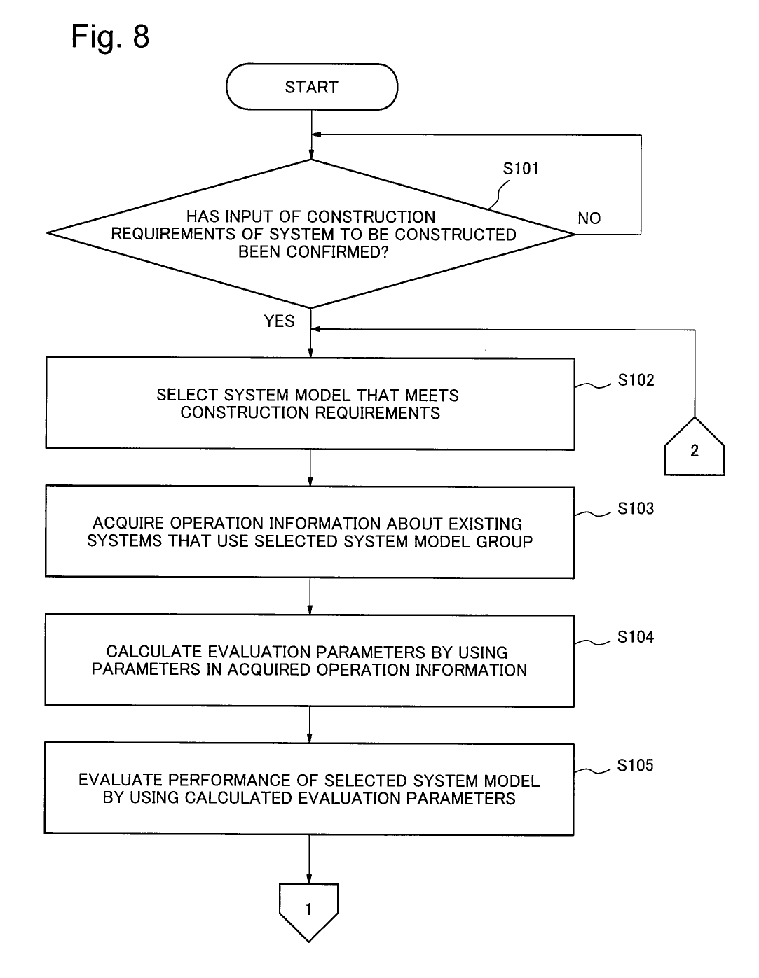

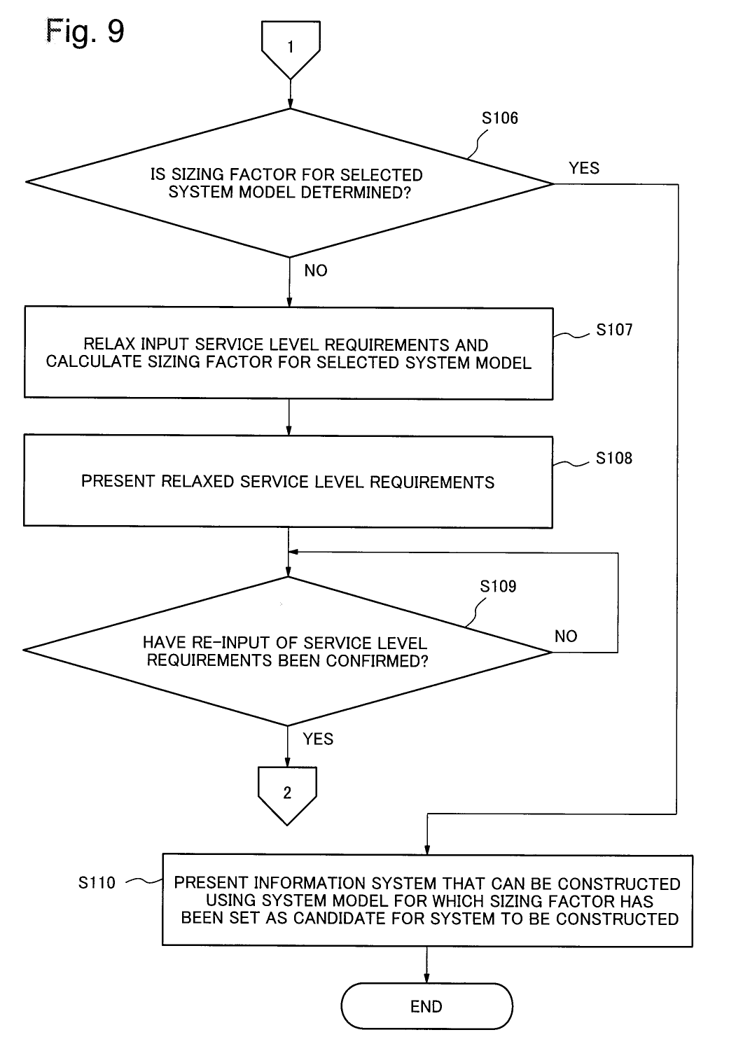

An operation of the information system construction assistance device 1 will be described with referenced to FIGS. 8 and 9. FIGS. 8 and 9 are flowcharts illustrating a procedure in assisting in constructing an information system.

First, the system model selection unit 11 determines whether or not inputs of the functional requirements and the service level requirements of the system to be constructed by the user have been confirmed (step S101). When the determination is negative (NO at step S101), the system model selection unit 11 waits until the determination becomes positive.

On the other hand, when it is determined at step S101 that the inputs of the functional requirements and the service level requirements have been confirmed (YES at step S101), the system model selection unit 11 selects a system model that meets the functional requirements and the service level requirements with reference to the system model information DB 2 (step S102). If a plurality of system models are selected, the user is allowed to select any one of the system model to choose a single system model at step S102.

Then the operation information acquisition unit 12 acquires operation information about existing systems that use the system model selected at step S102 and a system model similar to the system model from the operation information DB 3 (step S103).

Then the parameter calculation unit 13 uses parameters included in the operation information acquired at step S103 to calculate evaluation parameters used in evaluating non-functional requirements for the information system (step S104).

Then the performance evaluation unit 14 uses the evaluation parameters calculated at step S104 to evaluate the performance of the system model selected at step S102 (step S105).

Then the sizing factor determination unit 15 compares the results of the evaluation at step S105 with the service level requirements input at step S101. As a result of the comparison, the sizing factor determination unit 15 determines whether or not a sizing factor for the system model selected at step S102 is specified while maintaining at least the service level requirements set as being mandatory among the service level requirements (step S106).

If the determination at step S106 is negative (No at step S106), the sizing factor calculation unit 16 relaxes the service level requirements input at step S101 and calculates a sizing factor in the system model selected at step S102 (step S107).

Then the relaxed conditions presentation unit 17 presents the service level requirements relaxed at step S107 to the user (step S108).

Then the process waits (No at step S109) until re-input of the service level requests is confirmed. When the re-input of the service level requirements is confirmed (Yes at step S109), the process proceeds to step S102 described above.

On the other hand, if it is determined at step S106 that a sizing factor for the system model is specified (Yes at step S106), the candidate system-to-construct presentation unit 18 presents an information system that can be constructed in accordance with the system model for which the sizing factor has been set at step S106 to the user as a candidate for the system to be constructed (step S110).

As described above, in the information system construction assistance device 1 in the exemplary embodiment, the system model selection unit 11 selects a system model that meets functional requirements and service level requirements input by the user. The operation information acquisition unit 12 acquires operation information about existing systems relating to the selected system model group. The parameter calculation unit 13 uses the parameters included in the acquired operation information to calculate evaluation parameters. The performance evaluation unit 14 uses the evaluation parameters to evaluate the selected system model. The sizing factor determination unit 15 compares the performance of the evaluated system model with the input service level requirements to determine whether or not a sizing factor for the selected system model is specified. If it is determined that a sizing factor is not specified, the sizing factor calculation unit 16 relaxes the input service level requirements and calculates the sizing factor. The relaxed conditions presentation unit 17 presents the relaxed service level requirements.

Thus the information system construction assistance device 1 can select a system model that meets the construction requirements input by the user as a candidate for the system to be constructed. Furthermore, the information system construction assistance device 1 can evaluate non-functional requirements for the selected system model by using evaluation parameters calculated on the basis of operation information about existing systems relating to the selected system model group. The information system construction assistance device 1 compares the results of the evaluation and the service level requirements input by the user and, if a sizing factor for the selected system model is not specified, the information system construction assistance device 1 can relax the service level requirements and calculate the sizing factor, then present the relaxed service level requirements to the user.

Therefore, the information system construction assistance device 1 in the exemplary embodiment enables construction assistance that meets user demands to be simply implemented.

Note that the exemplary embodiment described above is illustrative only and is not intended to exclude application of various variations or techniques that are not explicitly stated in the exemplary embodiment. In other words, the present invention can be implemented in various variations without departing from the spirit of the present invention.

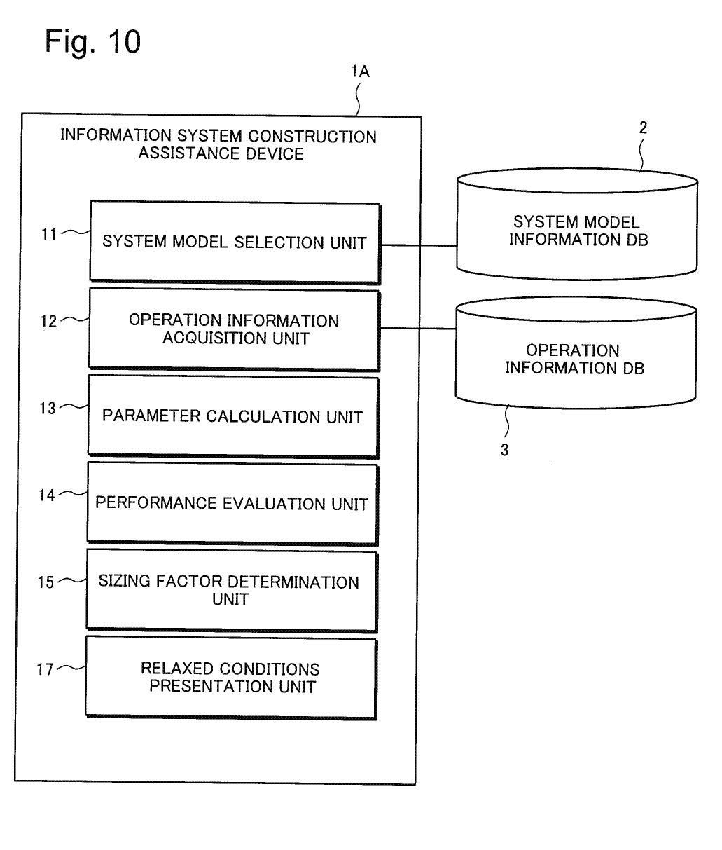

For example, while the information system construction assistance device 1 in the exemplary embodiment described above includes the functional components illustrated in FIG. 1, the information system construction assistance device according to the present invention is not limited to the configuration. FIG. 10 is a diagram illustrating another configuration of the information system construction assistance device according to the present invention. The information system construction assistance device 1A illustrated in FIG. 10 is similar to the information system construction assistance device 1 illustrated in FIG. 1 except that the sizing factor calculation unit 16 and the candidate system-to-construct presentation unit 18 are omitted. The omitted functions can be provided in external devices that can be connected through a network.

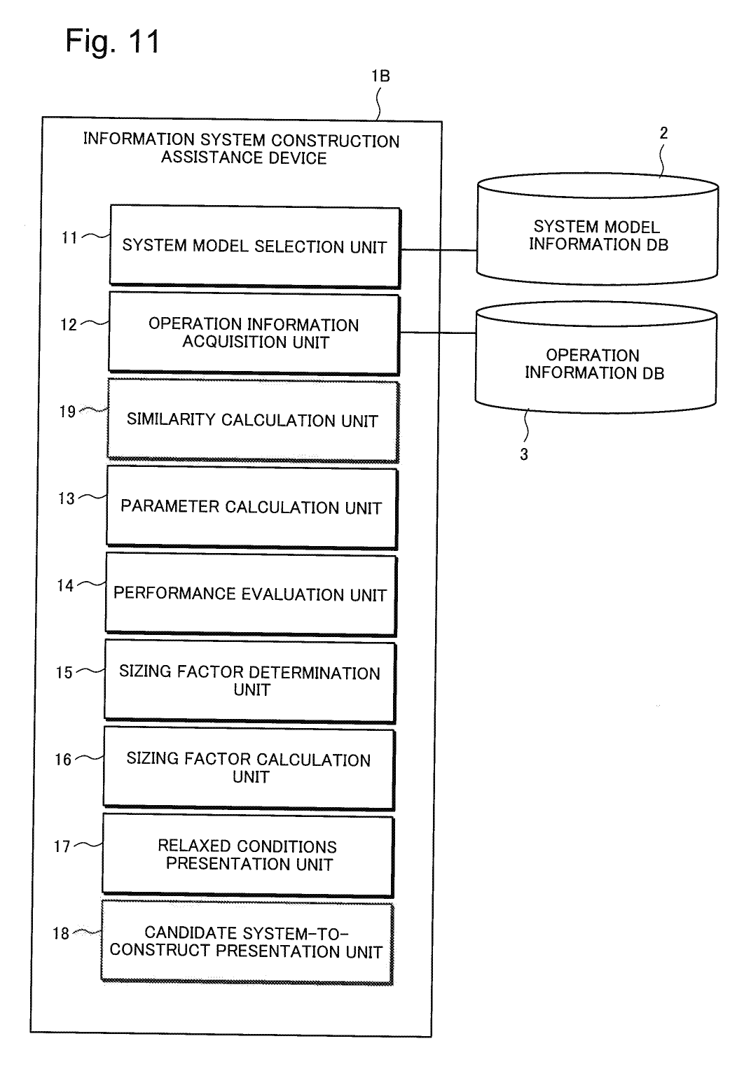

The following similarity calculating function may be optionally added to the information system construction assistance device in the exemplary embodiment described above. An information system construction assistance device in this variation will be described with reference to FIG. 11.

The information system construction assistance device 1B in the variation differs from the information system construction assistance device 1 in the exemplary embodiment described above in that a similarity calculation unit 19 is added and that the functions of the sizing factor determination unit 15 and the sizing factor calculation unit 16 are partially altered. The other components are the same as those of the information system construction assistance device 1 in the exemplary embodiment described above. Therefore like components are given like reference numerals and the description of those components will be omitted.

Differences from the exemplary embodiments described above will be primarily described below.

The similarity calculation unit 19 compares parameters included in operation information acquired by an operation information acquisition unit 12 with input construction requirements and calculates the degree of similarity between each item of operation information and each input construction requirement.

A sizing factor determination unit 15 and a sizing factor calculation unit 16 determine a sizing factor by setting the reciprocal of the degree of similarity calculated by the similarity calculation unit 19 as an element of uncertainty and using robust optimization, which will be described later.

Uncertainty and robust optimization will be described. There are various kinds of uncertainty in problems in the real world in general. For example, when a problem of planning future production is modeled, past data is often used in setting predictive values for feature demand or cost. These values include prediction errors, which can be factors for uncertainty. Robust optimization is known as an approach that deals with such uncertainty. The robust optimization is a technique in which a range of uncertainty is set beforehand and an occurrence of the worst case in the range is assumed to perform optimization. Accordingly a system optimized by using the robust optimization can achieve its object even when the predictable worst case occurs.

In this variation, the reciprocal of the degree of similarity calculated by the similarity calculation unit 19 is set as an element of uncertainty and a sizing factor is set such that construction requirements are met even when the assumable worst value, which may be the reciprocal of the degree of similarity, is reached.

Thus, the information system construction assistance device 1B in this variation has the advantageous effect of being capable of providing an information system that can achieve its object to users even when a predictable worst case occurs, in addition to the advantageous effect of the information system construction assistance device 1 in the exemplary embodiments described above.

A part or whole of the exemplary embodiments described above can be written as, but not limited to, the following supplementary notes.

(Supplementary Note 1) an Information System Construction assistance device including: a system model selection unit which, when a construction requirement for a system to be constructed which is an information system to be constructed is input, selects a system model that meets the construction requirements from among system models, the system models being set for each of sets of system design information stored in advance; an operation information acquisition unit which acquires operation information about existing systems, the existing systems being information systems already constructed on the basis of the system model selected by the system model selection unit and a similar system model similar to the system model; a parameter calculation unit which uses a parameter included in the operation information acquired by the operation information acquisition unit to calculate an evaluation parameter to be used in evaluating performance of the system model; a performance evaluation unit which uses the evaluation parameter calculated by the parameter calculation unit to evaluate performance of the system model selected by the system model selection unit; a server factor determination unit which compares the performance of the system model evaluated by the performance evaluation unit with the input construction requirements to determine whether or not a server factor is specified while maintaining at least one or more of the construction requirements that are set mandatory, the server factor being a factor for determining a size relating to a server included in the design information about the system model selected by the system model selection unit; and a relaxed conditions presentation unit which, when the server factor determination unit determines that the server factor is not specified, presents a relaxed version of the construction requirements.
(Supplementary note 2) The information system construction assistance device according to Supplementary note 1, further including a similarity calculation unit which compares a parameter included in the operation information acquired by the operation information acquisition unit with the input construction requirements and calculates the degree of similarity between each item of the operation information and the input construction requirements; and a server factor calculation unit which, when the server factor determination unit determines that the server factor is not specified, relaxes the input construction requirements and calculates the server factor; wherein when the server factor determination unit determines whether or not the server factor is specified, the server factor determination unit sets the reciprocal of the degree of similarity calculated by the similarity calculation unit as an element of uncertainty and uses robust optimization to calculate the server factor; the server factor calculation unit sets the reciprocal of the degree of similarity calculated by the similarity calculation unit as an element of uncertainty and uses robust optimization to calculate the server factor; and the relaxed conditions presentation unit presents the construction requirements relaxed by the server factor calculation unit.
(Supplementary note 3) The information system construction assistance device according to Supplementary note 1 or 2, wherein the construction requirements include a functional requirement for determining a function of an application and a service level requirement for determining a guaranteed level of quality provided by the system to be constructed; the sever factor determination unit compares the performance of the system model evaluated by the performance evaluation unit with the input service level requirements to determine whether or not the server factor is specified while maintaining at least one or more of the service level requirements that are set mandatory; when the server factor determination unit determines that the server factor is not specified, the server factor calculation unit relaxes the input service level requirements and calculates the server factor; and the relaxed conditions presentation unit presents the service level requirements relaxed by the server factor calculation unit.
(Supplementary note 4) The information system construction assistance device according to any one of Supplementary notes 1 to 3, further including a candidate system-to-construct presentation unit which, when the server factor determination unit determines that the server factor is specified, presents an information system that can be constructed using the system model for which the server factor is set as a candidate for the system to be constructed.
(Supplementary note 5) The information system construction assistance device according to any one of Supplementary notes 1 to 4, wherein the similar system model is the system model of another set of the design information in which only the server factor is different in the design information about the system model selected by the system model selection unit.
(Supplementary note 6) The information system construction assistance device according to any one of Supplementary notes 1 to 5, wherein the performance of the system model is a non-functional requirement.
(Supplementary note 7) An information system construction assistance method, including: a system model selection step of, when a construction requirement for a system to be constructed which is an information system to be constructed is input, selecting a system model that meets the construction requirements from among system models, the system models being set for each of sets of system design information stored in advance; an operation information acquisition step of acquiring operation information about existing systems, the existing systems being information systems already constructed on the basis of the system model selected at the system model selection step and a similar system model similar to the system model; a parameter calculation step of using a parameter included in the operation information acquired at the operation information acquisition step to calculate an evaluation parameter to be used in evaluating performance of the system model; a performance evaluation step of using the evaluation parameter calculated at the parameter calculation step to evaluate performance of the system model selected at the system model selection step; a server factor determination step of comparing the performance of the system model evaluated at the performance evaluation step with the input construction requirements to determine whether or not a server factor is specified while maintaining at least one or more of the construction requirements that are set mandatory, the server factor being a factor that determines a size relating to a server included in the design information about the system model selected at the system model selection step; and a relaxed conditions presentation step of, when it is determined at the server factor determination step that the server factor is not specified, presenting a relaxed version of the construction requirements.
(Supplementary note 8) The information system construction assistance method according to Supplementary note 7, further including: a similarity calculation step of comparing a parameter included in the operation information acquired at the operation information acquisition step with the input construction requirements and calculating the degree of similarity between each item of the operation information and the input construction requirements; and a server factor calculation step of, when it is determined at the server factor determination step that the server factor is not specified, relaxing the input construction requirements and calculating the server factor; wherein when determination is made at the server factor determination step as to whether or not the server factor is specified, the reciprocal of the degree of similarity calculated at the similarity calculation step is set as an element of uncertainty and robust optimization is used to calculate the server factor; at the server factor calculation step, the reciprocal of the degree of similarity calculated at the similarity calculation step is set as an element of uncertainty and robust optimization is used to calculate the server factor; and at the relaxed conditions presentation step, the construction requirements relaxed at the server factor calculation step is presented.
(Supplementary note 9) The information system construction assistance method according to Supplementary note 7 or 8, wherein the construction requirements include a functional requirement for determining a function of an application and a service level requirement for determining a guaranteed level of quality provided by the system to be constructed; at the sever factor determination step, the performance of the system model evaluated at the performance evaluation step is compared with the input service level requirements to determine whether or not the server factor is specified while maintaining at least one or more of the service level requirements that are set mandatory; when it is determined at the server factor determination step that the server factor is not specified, the input service level requirements are relaxed and the server factor is calculated at the server factor calculation step; and at the relaxed conditions presentation step, the service level requirements relaxed at the server factor calculation step are presented.
(Supplementary note 10) The information system construction assistance method according to any one of Supplementary notes 7 to 9, further including a candidate system-to-construct presentation step of, when it is determined at the server factor determination step that the server factor is specified, presenting an information system that can be constructed using the system model for which the server factor is set as a candidate for the system to be constructed.
(Supplementary note 11) The information system construction assistance method according to any one of Supplementary notes 7 to 10, wherein the similar system model is the system model of another set of the design information in which only the server factor is different in the design information about the system model selected at the system model selection step.
(Supplementary note 12) The information system construction assistance method according to any one of Supplementary notes 7 to 11, wherein the performance of the system model is a non-functional requirement.
(Supplementary note 13) An information system construction assistance program causing a computer to execute: a system model selection step of, when a construction requirement for a system to be constructed which is an information system to be constructed is input, selecting a system model that meets the construction requirements from among system models, the system models being set for each of sets of system design information stored in advance; an operation information acquisition step of acquiring operation information about existing systems, the existing systems being information systems already constructed on the basis of the system model selected at the system model selection step and a similar system model similar to the system model; a parameter calculation step of using a parameter included in the operation information acquired at the operation information acquisition step to calculate an evaluation parameter to be used in evaluating performance of the system model; a performance evaluation step of using the evaluation parameter calculated at the parameter calculation step to evaluate performance of the system model selected at the system model selection step; a server factor determination step of comparing the performance of the system model evaluated at the performance evaluation step with the input construction requirements to determine whether or not a server factor is specified while maintaining at least one or more of the construction requirements that are set mandatory, the server factor being a factor that determines a size relating to a server included in the design information about the system model selected at the system model selection step; and a relaxed conditions presentation step of, when it is determined at the server factor determination step that the server factor is not specified, presenting a relaxed version of the construction requirements.
(Supplementary note 14) The information system construction assistance program according to Supplementary note 13, further including: a similarity calculation step of comparing a parameter included in the operation information acquired at the operation information acquisition step with the input construction requirements and calculating the degree of similarity between each item of the operation information and the input construction requirements; and a server factor calculation step of, when it is determined at the server factor determination step that the server factor is not specified, relaxing the input construction requirements and calculating the server factor; wherein when determination is made at the server factor determination step as to whether the server factor is specified or not, the reciprocal of the degree of similarity calculated at the similarity calculation step is set as an element of uncertainty and robust optimization is used to calculate the server factor; at the server factor calculation step, the reciprocal of the degree of similarity calculated at the similarity calculation step is set as an element of uncertainty and robust optimization is used to calculate the server factor; and at the relaxed conditions presentation step, the construction requirements relaxed at the server factor calculation step is presented.
(Supplementary note 15) The information system construction assistance program according to Supplementary note 13 or 14, wherein the construction requirements include a functional requirement for determining a function of an application and a service level requirement for determining a guaranteed level of quality provided by the system to be constructed; at the sever factor determination step, the performance of the system model evaluated at the performance evaluation step is compared with the input service level requirements to determine whether or not the server factor is specified while maintaining at least one or more of the service level requirements that are set mandatory; when it is determined at the server factor determination step that the server factor is not specified, the input service level requirements are relaxed and the server factor is calculated at the server factor calculation step; and at the relaxed conditions presentation step, the service level requirements relaxed at the server factor calculation step are presented.
(Supplementary note 16) The information system construction assistance program according to any one of Supplementary notes 13 to 15, further including a candidate system-to-construct presentation step of, when it is determined at the server factor determination step that the server factor is specified, presenting an information system that can be constructed using the system model for which the server factor is set as a candidate for the system to be constructed.
(Supplementary note 17) The information system construction assistance program according to any one of Supplementary notes 13 to 16, wherein the similar system model is the system model of another set of the design information in which only the server factor is different in the design information about the system model selected at the system model selection step.

(supplementary note 18) The information system construction assistance program according to any one of Supplementary notes 13 to 17, wherein the performance of the system model is a non-functional requirement.

This application is based upon and claims the benefit of priority from Japanese Patent Application No. 2012-220617, filed on Oct. 2, 2012, the entire disclosure of which is incorporated herein.

### REFERENCE SIGNS LIST

1, 1A, 1B . . . Information system construction assistance device
2 . . . System model information DB
3 . . . Operation information DB
11 . . . System model selection unit
12 . . . Operation information acquisition unit
13 . . . Parameter calculation unit
14 . . . Performance evaluation unit
15 . . . Sizing factor determination unit
16 . . . Sizing factor calculation unit
17 . . . Relaxed conditions presentation unit
18 . . . Candidate system-to-construct presentation unit
19 . . . Similarity calculation unit
20 . . . CPU
30 . . . Storage device
40 . . . Input and output interface
50 . . . Bus
60 . . . Storage medium
70 . . . Drive device

What is claimed is:

1. An information system construction assistance device comprising:
a system model selection unit which, when a construction requirement for a system to be constructed which is an information system to be constructed is input, selects a system model that meets the construction requirements from among system models, the system models being set for each of sets of system design information stored in advance;
an operation information acquisition unit which acquires operation information about existing systems, the existing systems being information systems already constructed, on the basis of the system model selected by the system model selection unit and a similar system model similar to the system model;
a parameter calculation unit which uses a parameter included in the operation information acquired by the operation information acquisition unit to calculate an evaluation parameter to be used in evaluating performance of the system model;
a performance evaluation unit which uses the evaluation parameter calculated by the parameter calculation unit to evaluate performance of the system model selected by the system model selection unit;
a server factor determination unit which compares the performance of the system model evaluated by the performance evaluation unit with the input construction requirements to determine whether or not a server factor is specified while maintaining at least one or more of the construction requirements that are set mandatory, the server factor being a factor for determining a size relating to a server included in the design information about the system model selected by the system model selection unit; and
a relaxed conditions presentation unit which, when the server factor determination unit determines that the server factor is not specified, presents a relaxed version of the construction requirements.

2. The information system construction assistance device according to claim 1, further comprising:
a similarity calculation unit which compares a parameter included in the operation information acquired by the operation information acquisition unit with the input construction requirements and calculates the degree of similarity between each item of the operation information and the input construction requirements; and
a server factor calculation unit which, when the server factor determination unit determines that the server factor is not determined, relaxes the input construction requirements and calculates the server factor;
wherein when the server factor determination unit determines whether or not the server factor is specified, the server factor determination unit sets the reciprocal of the degree of similarity calculated by the similarity calculation unit as an element of uncertainty and uses robust optimization to calculate the server factor;
the server factor calculation unit sets the reciprocal of the degree of similarity calculated by the similarity calculation unit as an element of uncertainty and uses robust optimization to calculate the server factor; and
the relaxed conditions presentation unit presents the construction requirements relaxed by the server factor calculation unit.

3. The information system construction assistance device according to claim 1,
wherein the construction requirements include a functional requirement for determining a function of an application and a service level requirement for determining a guaranteed level of quality provided by the system to be constructed;
the sever factor determination unit compares the performance of the system model evaluated by the performance evaluation unit with the input service level requirements to determine whether or not the server factor is specified while maintaining at least one or more of the service level requirements that are set mandatory;
when the server factor determination unit determines that the server factor is not specified, the server factor calculation unit relaxes the input service level requirements and calculates the server factor; and
the relaxed conditions presentation unit presents the service level requirements relaxed by the server factor calculation unit.

4. The information system construction assistance device according to claim 1, further comprising a candidate system-to-construct presentation unit which, when the server factor determination unit determines that the server factor is specified, presents an information system that can be constructed using the system model for which the server factor is set as a candidate for the system to be constructed.

5. The information system construction assistance device according to claim 1, wherein the similar system model is the system model of another set of the design information in which only the server factor is different in the design information about the system model selected by the system model selection unit.

6. The information system construction assistance device according to claim 1, wherein the performance of the system model is a non-functional requirement.

7. An information system construction assistance method, comprising:
when a construction requirement for a system to be constructed which is an information system to be constructed is input, selecting a system model that meets the construction requirements from among system models, the system models being set for each of sets of system design information stored in advance;
acquiring operation information about existing systems, the existing systems being information systems already constructed on the basis of the system model selected in the selecting of the system model and a similar system model similar to the system model;
by using a parameter included in the operation information acquired in the acquiring of the operation information, calculating an evaluation parameter to be used in evaluating performance of the system model;
by using the evaluation parameter calculated in the calculating of the evaluation parameter, evaluating performance of the system model selected in the selecting of the system model;
by comparing the performance of the system model evaluated in the evaluating of the performance with the input construction requirements determining, whether or not a server factor is specified while maintaining at least one or more of the construction requirements that are set mandatory, the server factor being a factor for determining a size relating to a server included in the design information about the system model selected in the selecting of the system model; and
when it is determined in the determining of whether or not the server factor is specified that the server factor is not specified, presenting a relaxed version of the construction requirements.

8. The information system construction assistance method according to claim 7, further comprising:
by comparing a parameter included in the operation information acquired in the acquiring of the operation information with the input construction requirements, calculating the degree of similarity between each item of the operation information and the input construction requirements; and
when it is determined in the determining of whether or not the server factor is specified that the server factor is not specified, by relaxing the input construction requirements, calculating the server factor;
wherein when determination is made in the determining of the server factor as to whether or not the server factor is specified, the reciprocal of the degree of similarity calculated in the calculating of the similarity is set as an element of uncertainty and robust optimization is used to calculate the server factor;
in the calculating of the server factor, the reciprocal of the degree of similarity calculated in the calculating of the similarity is set as an element of uncertainty and robust optimization is used to calculate the server factor; and
in the relaxing of the conditions, the construction requirements relaxed in the calculating of the server factor is presented.

9. The information system construction assistance method according to claim 7,
wherein the construction requirements include a functional requirement for determining a function of an application and a service level requirement for determining a guaranteed level of quality provided by the system to be constructed;
in the determining of the server factor, the performance of the system model evaluated in the evaluating of the performance is compared with the input service level requirements to determine whether or not the server factor is specified while maintaining at least one or more of the service level requirements that are set mandatory;
when it is determined in the determining of the server factor that the server factor is not specified, the input service level requirements are relaxed and the server factor is calculated in the calculating of the server factor; and
in the presenting the relaxed version, the service level requirements relaxed in the calculating of the server factor are presented.

10. The information system construction assistance method according to claim 7, further comprising, when it is determined in the determining of the server factor that the server factor is specified, presenting an information system that can be constructed using the system model for which the server factor is set as a candidate for the system to be constructed.

11. The information system construction assistance method according to claim 7, wherein the similar system model is the system model of another set of the design information in which only the server factor is different in the design information about the system model selected in the selecting of the system model.

12. The information system construction assistance method according to claim 7, wherein the performance of the system model is a non-functional requirement.

13. A non-transitory computer-readable recording medium that stores therein a program for causing a computer to function as:
when a construction requirement for a system to be constructed which is an information system to be constructed is input, selecting a system model that meets the construction requirements from among system models, the system models being set for each of sets of system design information stored in advance;
acquiring operation information about existing systems, the existing systems being information systems already constructed on the basis of the system model selected in the selecting of the system model and a similar system model similar to the system model;
by using a parameter included in the operation information acquired in the acquiring of the operation information, calculating an evaluation parameter to be used in evaluating performance of the system model;
by using the evaluation parameter calculated in the calculating of the evaluation parameter, evaluating performance of the system model selected in the selecting of the system model;
by comparing the performance of the system model evaluated in the evaluating of the performance with the input construction requirements, determining whether or not a server factor is specified while maintaining at least one or more of the construction requirements that are set mandatory, the server factor being a factor that determines a size relating to a server included in the design information about the system model selected in the selecting of the system model; and
when it is determined in the determining of whether or not a server factor is specified that the server factor is not specified, presenting a relaxed version of the construction requirements.

14. The recording medium according to claim 13, further comprising:
by comparing a parameter included in the operation information acquired in the acquiring of the operation information with the input construction requirements, calculating the degree of similarity between each item of the operation information and the input construction requirements; and
when it is determined in the determining of whether or not a server factor is specified that the server factor is not specified, by relaxing the input construction requirements, calculating the server factor;
wherein when determination is made in the determining as to whether or not the server factor is specified, the reciprocal of the degree of similarity calculated in the calculating of the degree of similarity is set as an element of uncertainty and robust optimization is used to calculate the server factor;
in the calculating of the server factor, the reciprocal of the degree of similarity calculated in the calculating of the degree of similarity is set as an element of uncertainty and robust optimization is used to calculate the server factor; and
in the presenting of the relaxed version, the construction requirements relaxed in the calculating of the server factor is presented.

15. The recording medium according to claim 13,
wherein the construction requirements include a functional requirement for determining a function of an application and a service level requirement for determining a guaranteed level of quality provided by the system to be constructed;
in the determining of whether or not a server factor is specified, the performance of the system model evaluated in the evaluating of the performance is compared with the input service level requirements to determine whether or not the server factor is specified while maintaining at least one or more of the service level requirements that are set mandatory;
when it is determined in the determining of whether or not a server factor is specified that the server factor is not specified, the input service level requirements are relaxed and the server factor is calculated in the calculating of the server factor; and
in the presenting of the relaxed version, the service level requirements relaxed in the calculating of the server factor are presented.

16. The recording medium according to claim 13, further comprising,
when it is determined in the determining of whether or not a server factor is specified that the server factor is specified, presenting an information system that can be constructed using the system model for which the server factor is set as a candidate for the system to be constructed.

17. The recording medium according to claim 13, wherein the similar system model is the system model of another set of the design information in which only the server factor is different in the design information about the system model selected in the selecting of the system model.

18. The recording medium according to claim 13, wherein the performance of the system model is a non-functional requirement.
